(19) United States
(12) Patent Application Publication
(10) Pub. No.: US 2010/0111181 A1
(43) Pub. Date: May 6, 2010

(54) VIDEO PROCESSING APPARATUS AND METHODS

(75) Inventors: To-Wei Chen, Taoyuan County (TW); Te-Hao Chang, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/265,796

(22) Filed: Nov. 6, 2008

(51) Int. Cl. H04N 7/12; H04N 11/02

(52) U.S. Cl. 375/240.16; 375/E07.094; 375/E07.104

(57) ABSTRACT

A video processing apparatus includes a video decoder and a post-processing device. The video decoder is provided for decoding a block-based compressed bitstream to generate a sequence of frames, wherein data of reference frames in the sequence of frames are provided for generating a current frame. The post-processing device couples to a first memory and the video decoder. The video decoder sequentially stores the sequence of frames on a block-by-block basis and in a decoding order into the first memory. The post-processing device acquires the sequence of frames block by block, extracts motion information, and performs post-processing according to the sequence of frames and the motion information.

### BACKGROUND OF THE INVENTION

1. Field of the Invention

The invention relates to apparatus and methods for processing a video bitstream, and more particularly to a video processing apparatus and methods capable of reducing memory requirement and improving processing efficiency.

2. Description of the Related Art

Generally, various encoding techniques, e.g. H.264, MEPG-2/4, AVC, etc, have been introduced to reduce the required memory size and transmission bandwidth for digital cinematic video. However, for real-time displaying or processing of the compressed video data, a large computational loading is accordingly induced. Also, during the decoding process, costs are increased for required memory and performing required operations are time-consuming.

FIG. 1 is a block diagram illustrating a conventional video decoder 110. As shown in FIG. 1, the video decoder 110 comprises a variable-length-decoding (VLD) unit 102, a motion compensator 104, an inverse transformation unit 106, an inverse quantization unit 108, an adder 112 and a memory 114.

The VLD unit 102 is provided for receiving a block-based compressed bitstream 120 and generating corresponding motion vectors 122 and quantized transformed coefficients 124. The bitstream 120 is encoded macroblock by macroblock. The quantized transformed coefficients 124 are then transmitted to the inverse transformation unit 106 and then to the inverse quantization unit 108 for obtaining reconstructed residues 130. The motion compensator 104 further generates a predicted block 134 according to the motion vectors 122 and reference data 126 from the memory 114. The adder 112 then adds the reconstructed residues 130 and the predicted block 134 to generate a reconstructed block 128, and the reconstructed blocks 128 are stored in the memory 114. A current frame 132 reconstructed from the reference data 126 and prediction error (residues) is determined and ready for display.

The current frame 132 is then output to a display device (not shown) pixel-by-pixel or stored into another line-based memory device (not shown) for further post-processing. In addition, a sequence of frames generated from the video decoder 110 is displayed or stored in a display order.

De-interlacing, noise reduction or super resolution operations may be provided for post-processing. For example, sample rates for most video sources are 24-30 frames per second and sample rates for most display devices range are 50-60 frames per second. Thus, after a sequence of frames are generated from the video decoder 110, a frame rate conversion post-processing process, such as motion judder cancellation (MJC), may be required to convert the sample rate up to the display frame rate. For the MJC technique, a frame is generated by spatially interpolating the position of objects and background from two successive frames based on motion information, in order to reduce judder artifacts. However, during the process of performing the motion judder cancellation, an additional block-based memory is also required. More specifically, a redundant process for rearranging or reordering the sequence of frames from the line-based memory device to the additional block-based memory may significantly degrade memory efficiency or cause continual page misses.

Therefore, a need exists for an improved method and apparatus capable of integrating video decoding and post-processing processes and reducing memory resource utilization, thereby enhancing the entire video processing performance.

### BRIEF SUMMARY OF THE INVENTION

In one aspect, the invention is directed at a video processing apparatus for decoding a block-based compressed bitstream into corresponding video data for display. An exemplary embodiment of such a video processing apparatus comprises a video decoder and a post-processing device. The video decoder generates a sequence of frames by decoding the block-based compressed bitstream, wherein data of reference frames in the sequence of frames are provided for generating a current frame. The post-processing device coupled to a first memory and the video decoder, comprises a motion estimation unit. The video decoder sequentially stores the sequence of frames on a block-by-block basis and in a decoding order into the first memory. The sequence of frames is acquired by the post-processing device block by block, and the motion estimation unit extracts motion information for post-processing.

In another aspect, the invention is directed at a video processing method for decoding a block-based compressed bitstream into corresponding video data for display. An exemplary embodiment of the video processing method comprises receiving a block-based compressed bitstream. Then, a sequence of frames is decoded from the block-based compressed bitstream by a video decoder, wherein reference frames in the sequence of frames are provided for generating a current frame. A first memory is provided for sequentially storing the sequence of frames on a block-by-block basis and in a decoding order output from the video decoder. Finally, the sequence of frames is acquired from the first memory by a post-processing device in the block-by-block basis to perform post-processing.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram illustrating a conventional video decoder;

FIG. 2 is a block diagram illustrating a video processing apparatus according to one embodiment of the invention;

FIG. 3 is a block diagram illustrating a video processing apparatus according to another embodiment of the invention;

FIG. 4 is a schematic illustrating a sequence of frames currently processed by the video decoder and the post-processing device of FIG. 2 or 3 in accordance with one embodiment of the invention; and

FIG. 5 is a flowchart illustrating a video processing method according to one embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

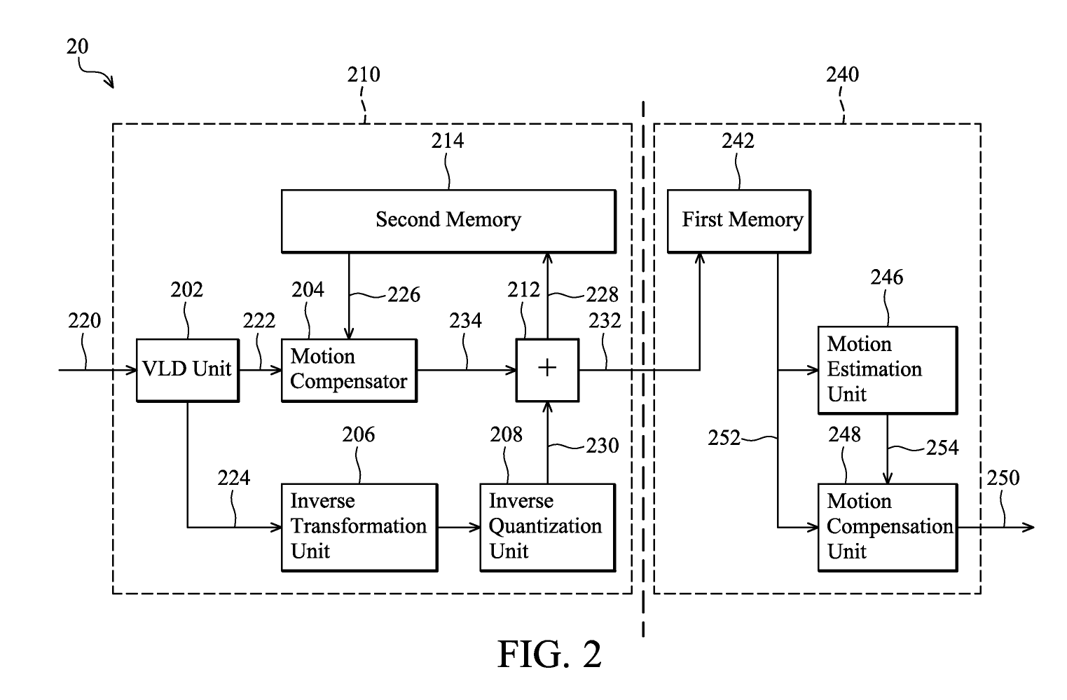

FIG. 2 is a block diagram illustrating a video processing apparatus 20 according to one embodiment of the invention. The video processing apparatus 20 comprises a video decoder 210 and a post-processing device 240. The video decoder 210 is provided for receiving a block-based compressed bitstream 220 and generating a sequence of frames according to the block-based compressed bitstream 220. A block is referred to as a macroblock according to one embodiment of the invention. That is, each frame may be divided into a plurality of macroblocks. In this embodiment, the post-processing device 240 is provided for performing motion judder cancellation for frame rate up-conversion. Thus, the post-processing device 240 comprises a first memory 242 coupled to the video decoder 210 for sequentially storing the sequence of frames on a block-by-block basis and in a decoding order. Then, the post-processing device 240 acquires the sequence of frames block by block and generates an interpolated frame 250 for display. Note that the addressing mode of the first memory is block-based. More specifically, the decoding order is different from the display order, as will be described in more detail herein below.

As shown in FIG. 2, the video decoder 210 comprises a variable-length-decoding (VLD) unit 202, a motion compensator 204, an inverse transformation unit 206, an inverse quantization unit 208, an adder 212 and a second memory 214. The VLD unit 202 generates motion vectors 222 and quantized transformed coefficients 224 according to the block-based compressed bitstream 220. As described above, the video decoder 210 employs some reference frames stored in the second memory 214 to generate a current frame 232. More specifically, the motion compensator 204 generates a predicted block 234 of the current frame 232 according to the motion vectors 222 and data of a previous or subsequent reference frame 226. According to the embodiment, the addressing mode of the second memory 214 is block-based capable of providing a reference block of the reference frame 226 for compensation.

For example, the previous or subsequent reference frame 226 may be an I-frame or P-frame provided for generating the current frame 232. The current frame 232 is a P-frame or a B-frame. In general, an I-frame is an intra-coded frame having a single image heading sequence without any reference to a previous or subsequent frame, a P-frame is referred as a forward-predicted frame encoded with reference to a previous I-frame or P-frame and a B-frame is encoded with reference to a previous reference frame, a subsequent reference frame, or both. In this regard, since B-frames use information from frames that will be displayed later (such as P-frames); the decoding order is accordingly different from the display order. In another example, assuming a series of video frames have a display order expressed as I1, B1, B2, P1, B3, B4 and P2, then, the sequence of frames decoded from the block-based compressed bitstream will have a decoding order represented as I1, P1, B1, B2, P2, B3 and B4. That is, reference frames, e.g. I-frames or P-frames, are required to be reconstructed prior to B-frames.

Further, the quantized transformed coefficients 224 are subsequently applied to the inverse transformation unit 206 to convert the quantized transformed coefficients 224 from a frequency domain to a spatial domain. Then, the inverse quantization unit 208 recovers reconstructed residues 230 for compensating the predicted block 234 of the current frame 232. The adder 212 adds the reconstructed residues 230 and the predicted block 234 to generate a reconstructed block 232, which is successively stored into the first memory 242 and arranged in the decoding order. In some embodiment, reconstructed blocks that will not be referenced are not stored into the second memory 214, only those that will be referenced by later frames are stored into the second memory 214 (through 228). For example, reconstructed blocks of a B-frame are not written into the second memory 214 as B-frame is not a reference frame.

Referring to FIG. 2, the post-processing device 240 comprises a motion estimation unit 246 and a motion compensation unit 248 for performing motion judder cancellation. In some other embodiments, the post-processing device 240 performs de-interlace, super resolution, noise reduction, or any post-process that requires motion estimation and motion compensation to generate post-processed video. In this embodiment, the motion estimation unit 246 is coupled to the first memory 242 for retrieving two or more frames 252 from the sequence of frames in a predetermined order in accordance with the motion judder cancellation. Since no additional data rearrangement or reorder is required for accessing the frames 252, it takes less time to complete the process and avoids undesired page missing.

Afterwards, the motion estimation unit 246 extracts motion information 254 associated with the frames 252. Note that the frames 252 supplied for performing motion judder cancellation are successive frames. More specifically, the motion estimation unit 246 generates motion information 254 of object movements in the two frames 252. Moreover, the motion compensation unit 248 is coupled to the first memory 242 and the motion estimation unit 246 for generating the interpolated frame 250 between the frames 252 in accordance with the motion information 254 from the motion estimation unit 246.

According to one embodiment of the invention, the video decoder further derives motion vectors and side information associated with the two frames 252 for generating the interpolated frame 250. In some embodiments, the side information comprises block mode information and the quantized transformed coefficients 224 (e.g., DC/AC coefficients) from the VLD unit 202, directional transform information from the inverse transformation unit 206, and quantization parameters from the inverse quantization unit 208. The block mode information provides sub-block information to indicate how the sub-block is being encoded. The DC/AC coefficients provide variation information of a given block for compensation. The directional transform information represent horizontal or vertical transform information of the given block. The quantization parameters for the given block provide a quality indication of a deterioration degree. The benefits of providing such side information for generating the interpolated frame 250 include improving processing efficiency and achieving a more reliable and smooth interpolated frame 250. For example, motion vectors and block mode information may be used to obtain initial guess for motion information for frame rate conversion.

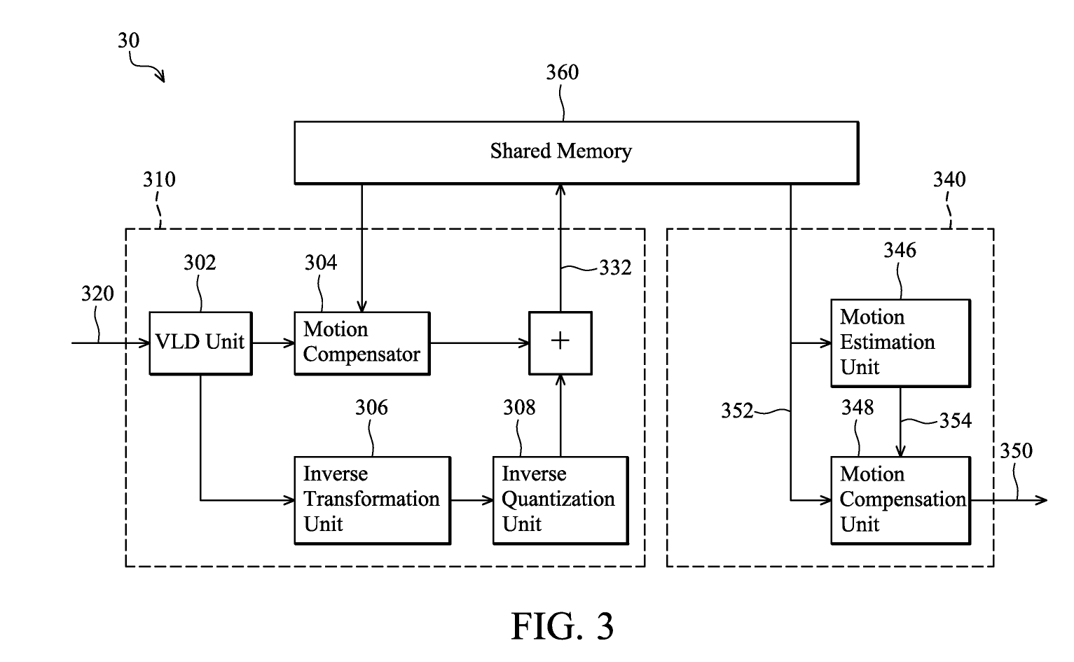

FIG. 3 is a block diagram illustrating a video processing apparatus 30 according to another embodiment of the invention. The video processing apparatus 30 comprises a shared memory 360, a video decoder 310 for decoding a bitstream 320, and a post-processing device 340 for performing motion judder cancellation. The video decoder 310 receives a block-based compressed bitstream 320 and generates a sequence of frames. In detail, the sequence of frames comprises reference frames provided for the video decoder 310 to generate a current frame 332. The video decoder 310 is similar to the video decoder 210 except that the sequence of frames, including non-reference frames, is stored into the shared memory 360, instead of storing the entire sequence of frames into the first memory 242 and storing only the reference frames into the second memory 212.

As shown in FIG. 3, the post-processing device 340 comprises a motion estimation unit 346 and a motion compensation unit 348. The motion estimation unit 346 extracts motion information 354 associated with two or more frames 352 obtained from the shared memory 360. The motion compensation unit 348 is coupled to the shared memory 360 and the motion estimation unit 346 for generating an interpolated frame 350 between the frames 352. Note that operation of the motion estimation unit 346 and the motion compensation unit 348 is substantially similar to those of FIG. 2, and hence, further description thereof is omitted for brevity. In this embodiment, the addressing mode of the shared memory 360 is block-based.

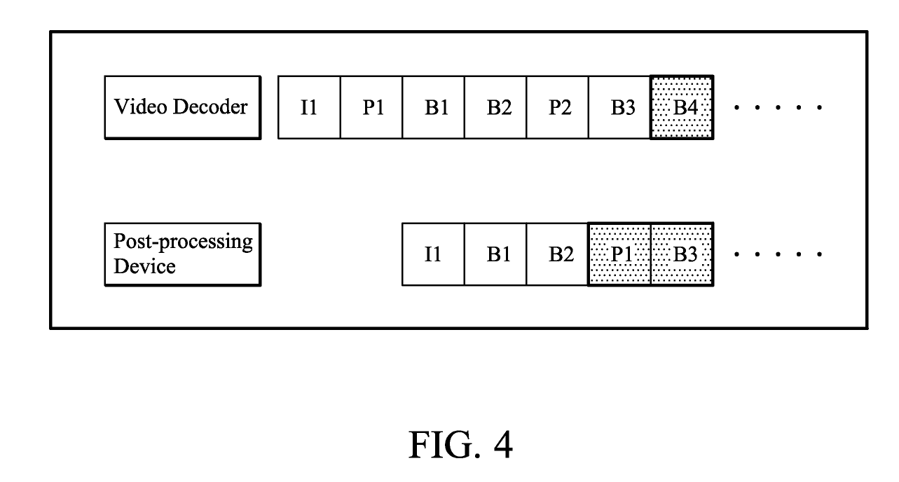

FIG. 4 is a schematic illustrating a sequence of frames currently processed by the video decoder and the post-processing device of FIGS. 2 and 3 in accordance with one embodiment of the invention. Similarly, the post-processing device is provided for performing motion judder cancellation in this embodiment. As shown in FIG. 4, it is assumed that the sequence of frames to be decoded is represented as I1, P1, B1, B2, P2, B3 and B4, where the letters I, P or B respectively denote an I-frame, P-frame or B-frame and the number denotes the decoding order of the frames.

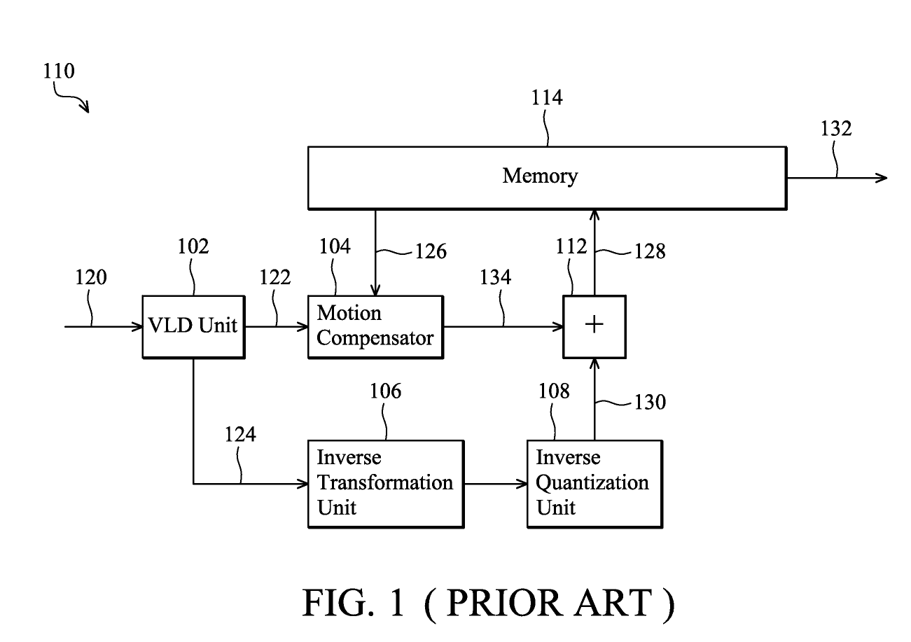

Referring to FIG. 4, assuming that the frame B4 is currently generated from the video decoder, the frame B4 is then passed into the first memory 242 of FIG. 2 or the shared memory 360 of FIG. 3 for storage. Meanwhile, the post-processing device acquires two frames P1 and B3 for generating an interpolated frame described in the foregoing, wherein the two frames P1 and B3 are previously decompressed by the video decoder. Therefore, instead of rearranging or reordering the two frames P1 and B3 from the line-based memory 114 of FIG. 1 to a block-based memory according to the prior art, the post-processing device of the invention directly retrieves the two frames P1 and B3 from the first memory 242 or the shared memory 360. Furthermore, because of the block-based addressing nature of the memory 242 or 360, the situation of page missing due to rearrangement according to the prior art is eliminated.

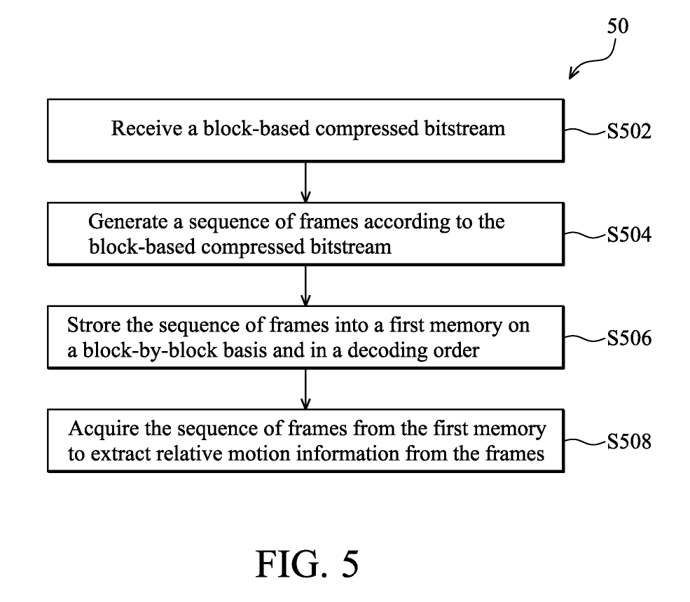

FIG. 5 is a flowchart illustrating a video processing method 50 according to one embodiment of the invention. First, a block-based compressed bitstream is received (step S502). In this embodiment, the process of decoding the block-based compressed bitstream is based on macroblocks. Then, a sequence of frames is generated according to the block-based compressed bitstream (step S504). In detail, data of some reference frames in the sequence of frames, such as I-frames or P-frames, are provided for generating a current frame (e.g., a P-frame or a B-frame). The process of generating the current frame according to the reference frames has been described in the aforementioned embodiments, and thus description thereof is omitted for brevity. Note that the reference frames may also be stored in a block-based second memory.

After the sequence of frames is obtained, the sequence of frames is sequentially stored into a first memory on a block-by-block basis and in a decoding order (step S506). It is to be noted that the addressing mode of the first memory and the second memory are block-based.

Next, the sequence of frames is acquired from the first memory to extract relative motion information from the frames (step S508). According to one embodiment, a process of motion judder cancellation is performed on two frames from the first memory in a predetermined order, so as to generate an interpolated frame. Specifically, the motion information extracted from two successive frames is used to estimate the movement of a given block within the interpolated frame. Also, motion vectors and side information associated with the two successive frames are provided for generating the interpolated frame between the two successive frames. As mentioned above, the side information comprises block mode information, DC/AC coefficients, and directional transform information and quantization parameters.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A video processing apparatus, comprising:
a video decoder for generating a sequence of frames by decoding a block-based compressed bitstream, wherein data of reference frames in the sequence of frames are provided for generating a current frame;
a first memory sequentially storing the sequence of frames output from the video decoder on a block-by-block basis and in a decoding order; and
a post-processing device coupled to the video decoder and the first memory, comprising a motion estimation unit, acquires the sequence of frames block by block from the first memory, extracts motion information from the sequence of frames for post-processing.

2. The video processing apparatus as claimed in claim 1, wherein the addressing mode of the first memory is block-based.

3. The video processing apparatus as claimed in claim 1, wherein the video decoder further derives motion vectors and side information associated with the sequence of frames for the post-processing device.

4. The video processing apparatus as claimed in claim 3, wherein the post-processing device comprises:
a motion compensation unit coupled to the first memory and the motion estimation unit for generating post-processed video in accordance with the motion information from the motion estimation unit.

5. The video processing apparatus as claimed in claim 4, wherein the motion compensation unit generates the post-processed video in accordance with the motion vectors and the side information from the video decoder.

6. The video processing apparatus as claimed in claim 3, wherein the side information comprises block mode information, DC coefficients, AC coefficients, directional transform information and quantization parameters.

7. The video processing apparatus as claimed in claim 1, wherein the video decoder acquires the data of reference frames from the first memory to generate the current frame.

8. The video processing apparatus as claimed in claim 1, wherein the video decoder comprises:
a second memory for storing the data of reference frames on a block-by-block basis and in the decoding order output from the video decoder,
wherein the video decoder acquires the data of reference frames from the second memory to generate the current frame.

9. The video processing apparatus as claimed in claim 1, wherein the motion estimation unit retrieves two frames from the sequence of frames in a predetermined order, extracting motion information associated with the two frames, and the post-processing device further comprises a motion compensation unit for generating an interpolated frame between the two frames according to the motion information extracted by the motion estimation unit.

10. The video processing apparatus as claimed in claim 9, wherein the interpolated frame is generated by performing motion judder cancellation processing on the two frames.

11. The video processing apparatus as claimed in claim 10, wherein the predetermined order is determined in accordance with motion judder cancellation.

12. The video processing apparatus as claimed in claim 9, wherein the two frames are successive frames.

13. A video processing method, comprising:
receiving a block-based compressed bitstream;
decoding the block-based compressed bitstream to generate a sequence of frames by a video decoder, wherein data of reference frames in the sequence of frames are provided for generating a current frame;
sequentially storing the sequence of frames output from the video decoder into a first memory on a block-by-block basis and in a decoding order;
acquiring the sequence of frames block by block from the first memory to extract motion information from the sequence of frames; and
performing post-processing on the sequence of frames based on the motion information.

14. The video processing method as claimed in claim 13, wherein the addressing mode of the first memory is block-based.

15. The video processing method as claimed in claim 13, wherein the step of decoding the sequence of frames comprises:
deriving motion vectors and side information associated with the sequence of frames.

16. The video processing method as claimed in claim 13, wherein the step of performing post-processing comprises:
retrieving two frames from the sequence of frames in a predetermined order;
extracting motion information associated with the two frames; and
generating an interpolated frame between the two frames in accordance with the motion information, the motion vectors and the side information.

17. The video processing method as claimed in claim 16, wherein the interpolated frame is generated by performing motion judder cancellation on the two frames.

18. The video processing method as claimed in claim 16, wherein the predetermined order is determined in accordance with motion judder cancellation.

19. The video processing method as claimed in claim 15, wherein the side information comprises block mode information, DC coefficients, AC coefficients, directional transform information and quantization parameters.

20. The video processing method as claimed in claim 13, wherein the reference frames are acquired from the first memory to generate the current frame.

21. The video processing method as claimed in claim 13, further comprising:
providing a second memory for storing the data of reference frames output from the video decoder on the block-by-block basis and in the decoding order; and
acquiring the data of reference frames from the second memory to generate the current frame,
wherein the addressing mode of the second memory is block-based.
